(19) United States
(12) Patent Application Publication
(10) Pub. No.: US 2007/0008391 A1
(43) Pub. Date: Jan. 11, 2007

(54) Solid inkjet printing device

(75) Inventors: Jeong-yeon Park, Ansan-si (KR); Young-min Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/475,080

(22) Filed: Jun. 27, 2006

(30) Foreign Application Priority Data
Jun. 28, 2005 (KR) 2005-56434

(51) Int. Cl. B41J 2/175

(52) U.S. Cl. 347/88

(57) ABSTRACT

A solid ink inkjet printing device is provided with an image forming member; an ink head unit having an ink chamber for reserving ink, and an ink head for supplying the ink to the image forming member to form an image on a printable medium; and an ink supply unit pressing solid ink to one side and melting an end of the pressed solid ink to supply the ink to the ink chamber. The ink supply unit is provided above the ink chamber and arranged such that the solid ink is pressed at an angle of no more than 30 degrees to the left or right of the direction in which the ink is supplied to the ink chamber.

### CROSS-REFERENCE TO RELATED APPLICATIONS

This application claims all benefits accruing under 35 U.S.C. § 119 from Korean Patent Application No. 10-2005-56434, filed on Jun. 28, 2005, in the Korean Intellectual Property Office, the disclosure of which is incorporated by reference herein.

### BACKGROUND OF THE INVENTION

1. Field of the Invention

The present invention relates to printing devices, and more particularly, to a solid inkjet printing device which fuses solid ink to form an image on a printable medium.

2. Related Art

Generally, printing devices such as printers, copying machines, and facsimile machines are designed to print an image on a printable medium such as a paper sheet or thin plastic plate on the basis of image information. Such printing devices can be classified into inkjet printing devices, dot matrix printing devices, laser beam printing apparatuses, and the like in accordance with their printing schemes. Of these schemes, the inkjet scheme is designed to print an image by discharging small droplets of ink from the orifices of an ink head unit (print head) and causing the droplets to fly and land on a printable medium. For solid inkjet printing devices, sticks of solid (wax-like) ink are melted and applied to the printable medium to form an image.

Such a solid inkjet printing device using solid ink comprises an ink supply unit that reserves solid ink and fuses the reserved ink to supply the ink for forming an image on a printable medium. The ink supply unit is generally provided with a solid ink reservoir unit which can carry solid ink for each color, for example, cyan, magenta, yellow and black (CMYK). The solid ink reservoir unit has a path through which the reserved ink for each color can travel. The solid ink loaded on the path is pressed to one side by a certain pressure member. The leading end of pressed solid ink is heated and fused by a certain heating plate to fall into an ink chamber.

The ink chamber is provided in an ink head unit for storing the fused ink supplied from the ink supply unit. An ink head is mounted on the ink head unit for supplying the ink from the ink chamber to a certain image forming drum to form an image on a printable medium.

The image formed on the image forming drum is transferred onto a printable medium supplied through certain passages so that final printing can be completed.

In such a typical structure of an inkjet printing device, the ink head unit receives the fused ink for printing an image on a printable medium. As a result, it is very important to ensure that ink is smoothly received from the ink supply unit.

Moreover, the ink supply unit must be provided adjacent to the ink head unit. As a result, the size of the inkjet printing device may be unnecessarily large. Therefore, it is very important to understand where and how the ink supply unit is installed in a solid inkjet printing device to ensure that ink is efficiently supplied and the overall size is kept small.

### SUMMARY OF THE INVENTION

Various aspects and example embodiments of the present invention provide an improved solid inkjet printing device which can increase efficiency of an ink supply unit and reduce the size of the printing device.

Additional aspects and/or advantages of the invention will be set forth in part in the description which follows and, in part, will be obvious from the description, or may be learned by practice of the invention.

In accordance with an aspect of the present invention, there is provided an solid ink inkjet printing device comprising an image forming member; an ink head unit having an ink chamber for reserving ink, and an ink head for supplying the ink to the image forming member to form an image; and an ink supply unit for pressing solid ink to one side and melting an end of the pressed solid ink to supply the ink to the ink chamber. The ink supply unit is provided above the ink chamber and arranged such that the solid ink can be pressed at an angle no more than 30 degrees to the left or right of the direction in which the ink is supplied to the ink chamber.

According to an aspect of the present invention, the ink supply unit may be vertically provided above the ink chamber of the ink head unit. The ink supply unit may be distanced from the ink head unit by a certain length. The direction pressing the solid ink may be in parallel with a direction dropping the ink to the ink chamber by gravity.

According to an aspect of the present invention, the ink supply unit may comprise a housing; an ink reservoir unit provided in the housing, for reserving the solid ink, and having a plurality of ink moving paths through which the reserved ink is guided along therein; a cover for covering the ink reservoir unit; a heating plate provided at one side of the ink moving path to heat the end of the solid ink; a pressure member for pressing the solid ink toward the heating plate; and a supporting frame engaged with the ink reservoir unit to support the heating plate.

In accordance with another aspect of the present invention, a print head assembly is provided for use in an inkjet printing device comprising: an ink chamber to reserve ink; a print head to print an image on a printable medium; an ink supply unit having one or more heating plates arranged at a distal end and a pressure member to press solid ink toward the one or more heating plates for melting the solid ink and dropping melted ink into the ink chamber; wherein the ink supply unit is positioned immediately above the ink chamber and arranged such that the solid ink is pressed at an angle no more than 30 degrees to left or right of a direction in which the melted ink is dropped into the ink chamber.

The ink supply unit is vertically provided above the ink chamber, and is positioned immediately above the ink chamber by a predetermined distance. The direction pressing the solid ink is in parallel with a direction dropping the ink to the ink chamber by gravity. In addition, the ink supply unit further comprises a housing; an ink reservoir unit provided in the housing, for reserving the solid ink, and having a plurality of ink moving paths through which the reserved ink of different colors is guided along therein; a cover to cover the ink reservoir unit; and a support frame operatively engaged with the ink reservoir unit to support the one or more heating plates, wherein the one or more heating plates are provided at a distal end of each ink moving path to heat and melt the solid ink, and the pressure member is provided at an opposite end of the ink moving paths to press the solid ink toward the one or more heating plates.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a schematic construction view of a solid inkjet printing device according to an embodiment of the present invention;

FIG. 2 is a partial perspective view of an ink supply unit taken from the solid inkjet printing device shown in FIG. 1;

FIG. 3 is an exploded perspective view of an important part of the ink supply unit shown in FIG. 2; and

FIG. 4 is a schematic view for explaining operations of the ink supply unit shown in FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

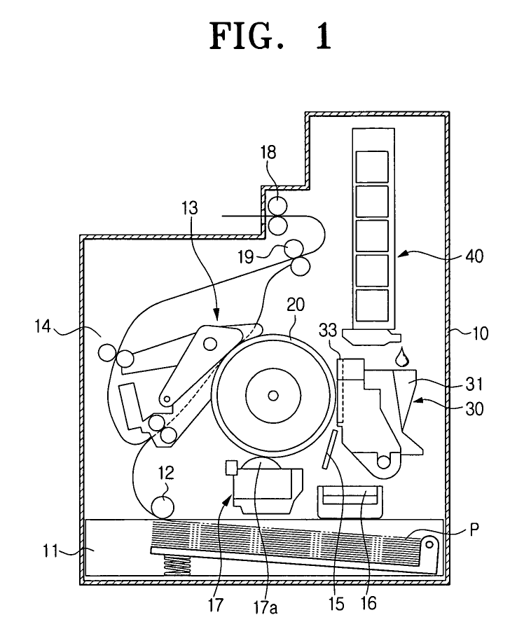

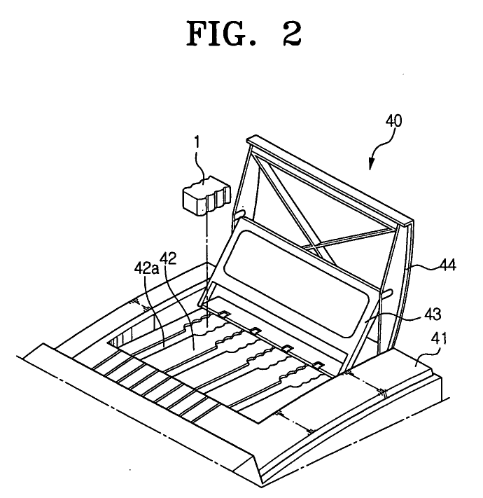

Referring to FIGS. 1 and 2, the solid inkjet printing device according to an embodiment of the present invention comprises a main body 10, an image forming drum 20 provided in the main body 10, an ink head unit (i.e., print head assembly) 30 for supplying ink to the drum 20 to form an image, and an ink supply unit 40 for supplying ink to the ink head unit 30.

A paper tray 11 is provided at a bottom portion of the main body 10 to feed a printable medium, such as a paper sheet P. One or more rollers 12 may be used to pull the paper P from the paper tray 11 and advance the paper when the ink head unit 30 is ready for another pass.

The image forming drum 20 is rotatably provided in the main body 10. A desired image is formed on the drum 20 by ink ejected from the ink head unit 30. The image formed on the image forming drum 20 is transferred onto the paper P that is supplied from the paper tray 11 and passing the image forming drum 20. A transfer pressure unit 13 is provided adjacent to the image forming drum 20 to press the image that is transferred to the paper P.

For a duplex printing of the paper P, a reverse unit 14 may be further provided to reverse the paper P having one side printed. Otherwise, one or more discharge rollers 18 and 19 may be used to discharge the paper P after the image is printed thereon.

The ink head unit 30 comprises an ink chamber 31 for reserving ink, and an ink head 33 provided at one side of the ink chamber 31. The ink head unit 30 is formed adjacent to the image forming drum 20. Although not shown, the ink chamber 31 may be divided into a plurality of chambers for reserving ink by each color, for example, cyan, magenta, yellow and black (CMYK). In other words, the ink head unit 30 may include up to four (4) different ink chambers 31 for storing ink of four (4) different colors such as, for example, cyan, magenta, yellow and black (CMYK). The ink head 33 jets ink of the ink chamber 31 onto the image forming drum 20 to form a certain image. The technical structure and operation of the ink head 33 are well known in the inkjet printing art and, as a result, will not be described in detail herein.

A cleaning blade 15 and a waste ink tray 16 are provided at one side of the image forming drum 20 to collect waste ink dropped from the ink head 33 and to reserve the waste ink falling down through the cleaning blade 15, respectively.

A drum maintenance kit 17 is provided at a lower portion of the image forming drum 20. Such a drum maintenance kit 17 includes a roller 17a moistened by oil to regulate and maintain the surface of the image forming drum 20. The drum maintenance kit 17 is provided such that the roller 17a can move upward to contact the surface of the image forming drum 20, and downward to remove from the image forming drum 20. Prior to forming an image onto the image forming drum 20, and rotating in contact with the image forming drum 20, the roller 17a applies oil onto the image forming drum 20 so as to regulate the drum surface.

The ink supply unit 40 is provided above the ink head unit 30. The ink supply unit 40 is widely used for an inkjet printing device using the solid ink, and therefore, the detailed description will be omitted for the sake of brevity. Only simple construction of the ink supply unit 40 according to an embodiment of the present invention will be described herein.

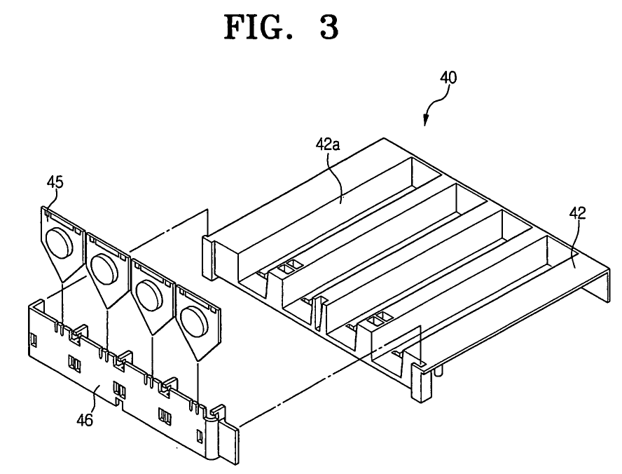

Referring to FIGS. 2 and 3, the ink supply unit 40 comprises an exterior housing 41, and a solid ink reservoir unit 42 provided in the housing 41 and having a plurality of moving paths 42a in which solid ink 1 is reserved and can be moved along the moving paths 42a.

The solid ink reservoir unit 42 can be opened and closed by a first protective cover 43, which, in turn, is covered by a second protective cover 44.

A plurality of solid ink in different colors can be sequentially reserved in the moving paths 42a. A plurality of heating plates 45 are then formed at one side of each moving path 42a to heat and melt the solid ink 1. As power is supplied thereto, the heating plates 45 melt the solid ink 1. Each heating plate 45 may have a sharp end to guide melted ink to one side. A supporting frame 46 is engaged with the solid ink reservoir unit 42, to support the heating plates 45 when the heating plates 45 are combined with the solid ink reservoir unit 42.

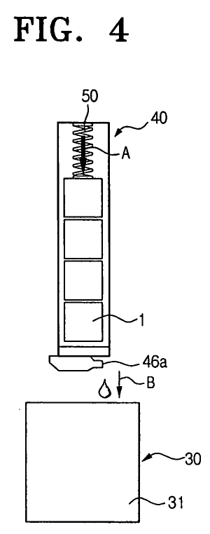

A pressure member 50, as shown in FIG. 4, is further provided to press the solid ink 1 on the moving paths 42a toward the heating plates 45. The pressure member 50 may be a plate spring or a coil spring formed at the other end of each moving path 42a in the ink supply unit 40, and press, via elasticity, the solid ink 1 downward toward the heating plates 45.

The ink supply unit 40 may be preferably arranged in a direction “A” to form an angle of no more than 30 degrees to the left or right of direction “B”. The direction “A” is for pressing the solid ink 1, and the direction “B” is for supplying the melted ink. More preferably, the direction “B” is in parallel with the gravity, and the ink supply unit 40 may be vertically provided so that the direction “A” can be in parallel with the direction “B”.

As described above, if the ink supply unit 40 is vertically provided above the ink head unit 30 having an ink chamber 31 by a certain distance, the following effects can be obtained as follows.

As shown in FIG. 4, the direction “A” pressing the solid ink 1 by using the pressure member 50 is vertical, such that the force pressing the solid ink 1 can increase and regular gravity force can be transmitted toward the direction “A”.

The direction “A” pressing the solid ink 1 is in parallel with the direction “B” supplying the ink, i.e., dropping the ink into the ink chamber 31 of the ink head unit 30 so that the ink can be more efficiently supplied to the ink head unit 30.

If the ink supply unit 40 is vertically formed, the left and right width of the inkjet printing device can be reduced so that the inkjet printing device can be kept slimmed or compact.

In accordance with an embodiment of the present embodiment, one or more supply nozzles 46a for supplying ink are formed at a bottom end of the ink supply unit 40 as shown in FIG. 4. However, this should not be considered as limiting. Various alternative configurations and constructions of the ink supply unit 40 may be available and can be utilized by a person skilled in the art. In addition, the ink head unit 30 includes four (4) different ink chambers 31 for four (4) different colors of ink. Moreover, as shown in FIG. 4, a plurality of solid inks are vertically arranged; however, a single solid ink can also be vertically arranged depending on the shape and/or size of ink. Furthermore, as shown in FIG. 3, melted solid ink drops from the vertex of the triangle of the heating plates 45 to the ink head unit 30. Accordingly, the distance between the ink supply unit 40 and the ink head unit 30 does not matter, and can range freely from a few millimeters to a few tens of millimeters.

In accordance with another embodiment of the present invention, the ink head unit 30 and the ink supply unit 40 can be integrated into a single print head assembly as long as solid ink can be pressed toward one or more heating plates at an angle no more than 30 degrees to left or right of a direction in which melted ink is dropped into an ink chamber 31 where the melted ink can be used by a print head to print an image on a printable medium. In such a single print head assembly, ink supply unit 40 is positioned immediately above the ink chamber 31 and arranged such that the solid ink is pressed at an angle no more than 30 degrees to left or right of a direction in which the melted ink is dropped into the ink chamber 31.

As described in the foregoing, the solid inkjet printing device according to an embodiment of the present invention has the ink supply unit arranged in a range of certain angles so that the direction pressing the solid ink is parallel with the direction supplying the ink. Therefore, the ink can be more efficiently supplied. Additionally, the direction pressing the solid ink is arranged in a direction of gravity so that the force can more regularly and efficiently press the solid ink toward the heating plates. Moreover, the ink supply unit is vertically provided so that the width, i.e., the size, of the inkjet printing device can be reduced.

While the present invention has been particularly shown and described with reference to exemplary embodiments thereof, it will be understood by those of ordinary skill in the art that various changes in form and details may be made therein without departing from the spirit and scope of the present invention. For example, components of an inkjet printing device, as shown in FIG. 1, can be arranged differently as long as the ink supply unit is vertically aligned with the ink heat unit so that solid ink can be pressed at an angle no more than 30 degrees to the left or right of a direction in which solid ink is supplied to the ink chamber within the ink heat unit. In addition, the ink supply unit, as shown in FIG. 2 and FIG. 3, can be arranged differently and contain different elements to supply ink to the ink heat unit. Moreover, the ink supply unit can be incorporated into a print head assembly as long as solid ink is pressed at an angle no more than 30 degrees to left or right of a direction in which melted ink is supplied to the ink chamber. Accordingly, it is intended, therefore, that the present invention not be limited to the various example embodiments disclosed, but that the present invention includes all embodiments falling within the scope of the appended claims.

What is claimed is:

1. A solid ink inkjet printing device comprising:
an image forming member to form an image on a printable medium;
an ink head unit having an ink chamber for reserving ink, and an ink head for supplying ink to the image forming member to form the image on the printable medium; and
an ink supply unit for providing solid ink to one side and melting an end of the pressed solid ink to supply the ink to the ink chamber;
wherein the ink supply unit is provided above the ink chamber and arranged such that the solid ink is pressed at an angle no more than 30 degrees to left or right of a direction in which the ink is supplied to the ink chamber.

2. The device according to claim 1, wherein the ink supply unit is vertically provided above the ink chamber of the ink head unit.

3. The device according to claim 2, wherein the ink supply unit is distanced from the ink head unit by a certain length.

4. The device according to claim 1, wherein the direction pressing the solid ink is in parallel with a direction dropping the ink to the ink chamber by gravity.

5. The device according to claim 1, wherein the ink supply unit comprises:
a housing;
an ink reservoir unit provided in the housing, for reserving the solid ink, and having a plurality of ink moving paths through which the reserved ink is guided along therein;
a cover to cover the ink reservoir unit;
a heating plate provided at one side of each ink moving path to heat the solid ink;
a pressure member for pressing the solid ink toward the heating plate; and
a supporting frame engaged with the ink reservoir unit to support the heating plate.

6. An inkjet printing device comprising:
an image forming member;
an ink head unit having an ink chamber to reserve ink, and an ink head to supply ink to the image forming member to form an image on a printable medium; and
an ink supply unit having one or more heating plates arranged at a distal end and a pressure member to press solid ink toward the one or more heating plates for melting the solid ink and dropping melted ink into the ink chamber;
wherein the ink supply unit is positioned immediately above the ink chamber and arranged such that the solid ink is pressed at an angle no more than 30 degrees to left or right of a direction in which the melted ink is dropped into the ink chamber.

7. The device according to claim 6, wherein the ink supply unit is vertically provided above the ink chamber of the ink head unit.

8. The device according to claim 7, wherein the ink supply unit is positioned immediately above the ink chamber by a predetermined distance.

9. The device according to claim 6, wherein the direction pressing the solid ink is in parallel with a direction dropping the ink to the ink chamber by gravity.

10. The device according to claim 6, wherein the ink supply unit further comprises:
a housing;
an ink reservoir unit provided in the housing, for reserving the solid ink, and having a plurality of ink moving paths through which the reserved ink of different colors is guided along therein;
a cover to cover the ink reservoir unit; and
a support frame operatively engaged with the ink reservoir unit to support the one or more heating plates,
wherein the one or more heating plates are provided at a distal end of each ink moving path to heat and melt the solid ink, and the pressure member is provided at an opposite end of the ink moving paths to press the solid ink toward the one or more heating plates.

11. A print head assembly for use in an inkjet printing device comprising:
an ink chamber to reserve ink;
a print head to print an image on a printable medium;
an ink supply unit having one or more heating plates arranged at a distal end and a pressure member to press solid ink toward the one or more heating plates for melting the solid ink and dropping melted ink into the ink chamber;
wherein the ink supply unit is positioned immediately above the ink chamber and arranged such that the solid ink is pressed at an angle no more than 30 degrees to left or right of a direction in which the melted ink is dropped into the ink chamber.

12. The print head assembly according to claim 11, wherein the ink supply unit is vertically provided above the ink chamber, and is positioned immediately above the ink chamber by a predetermined distance.

13. The print head assembly according to claim 11, wherein the direction pressing the solid ink is in parallel with a direction dropping the ink to the ink chamber by gravity.

14. The device according to claim 11, wherein the ink supply unit further comprises:
a housing;
an ink reservoir unit provided in the housing, for reserving the solid ink, and having a plurality of ink moving paths through which the reserved ink of different colors is guided along therein;
a cover to cover the ink reservoir unit; and
a support frame operatively engaged with the ink reservoir unit to support the one or more heating plates,
wherein the one or more heating plates are provided at a distal end of each ink moving path to heat and melt the solid ink, and the pressure member is provided at an opposite end of the ink moving paths to press the solid ink toward the one or more heating plates.
